(19) United States
(12) Patent Application Publication
(10) Pub. No.: US 2009/0049174 A1
(43) Pub. Date: Feb. 19, 2009

(54) System and method for managing access to resources and functionality of client computers in a client/server environment

(76) Inventor: Nicholas Rudnik, Winona, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/891,951

(22) Filed: Aug. 14, 2007

(51) Int. Cl. G06F 15/177; G06F 15/173

(52) U.S. Cl. 709/226; 713/2

(57) ABSTRACT

Methods, systems, and apparatus for managing at least one client computer in a client-server computing system. The start-up boot process of the client computer is interrupted before the standard operating system user initialization program is executed. One or more resources to be permitted for use on the client computer, such as a communicative connection with the server, are enabled. An alternative user interface program which may be either a remote desktop access program or a task-oriented computer program is executed. Upon termination of the alternative user interface program, the alternative user interface program is automatically reexecuted to prevent self-help access to resources by the user. The alternative user interface program serves as the sole user interface to the client computer, and limits access by the user to resources to only one or more permitted resources.

### FIELD OF THE INVENTION

This invention relates generally to computers and more particularly to managing access to resources and functionality of client computers in a client/server computing environment.

### COMPUTER PROGRAM LISTING APPENDIX

A computer program listing is included herewith in Compact Disk format as Appendix A to this application, the computer program listing consisting of one original disk and one duplicate. Each disk includes the following files:

| File Name | File Size (Bytes) | Date |
|---|---|---|
| App.csproj.FileList.txt | 776 | Aug. 14, 2007 |
| App.csproj.txt | 3629 | Aug. 14, 2007 |
| Mtdconfig.csproj.FileList.txt | 294 | Aug. 14, 2007 |
| Pctcmn.csproj.FileList.txt | 374 | Aug. 14, 2007 |
| Globals.cs.txt | 635 | Aug. 14, 2007 |
| Licensing.cs.txt | 2778 | Aug. 14, 2007 |
| MainOptionsForm.cs.txt | 1782 | Aug. 14, 2007 |
| MainOptionsForm.Designer.cs.txt | 6245 | Aug. 14, 2007 |
| MainOptionsForm.resx.txt | 4461 | Aug. 14, 2007 |
| ProcessListener.cs.txt | 327 | Aug. 14, 2007 |
| Program.cs.txt | 844 | Aug. 14, 2007 |
| RegistryInfo.cs.txt | 949 | Aug. 14, 2007 |
| RegistryInfoAgent.cs.txt | 1650 | Aug. 14, 2007 |
| RegistryLockdown.cs.txt | 1897 | Aug. 14, 2007 |
| Shell.cs.txt | 886 | Aug. 14, 2007 |
| Setup.vbs.txt | 1173 | Aug. 14, 2007 |
| Cleanup.vbs.txt | 549 | Aug. 14, 2007 |
| StartProcess.cs.txt | 2000 | Aug. 14, 2007 |
| Readme.txt | 1176 | Aug. 14, 2007 |
| AssemblyInfo.cs.txt | 643 | Aug. 14, 2007 |
| Resources.Designer.cs.txt | 1754 | Aug. 14, 2007 |
| Resources.resx.txt | 5609 | Aug. 14, 2007 |
| Settings.Designer.cs.txt | 681 | Aug. 14, 2007 |
| Settings.settings.txt | 246 | Aug. 14, 2007 |

The entire contents of the Compact Disk included herewith as Appendix A, including without limitation, the aforementioned files, is hereby incorporated herein by reference.

### BACKGROUND OF THE INVENTION

Computer systems in larger enterprise settings are typically configured in a client/server architecture. Client/server systems may be implemented using a “thin client” model, a “fat client” model, or a hybrid thereof. In a “thin client” model, the server performs most of the processing activity, and the client computer is focused primarily on conveying input and output between the user and the server. By contrast, in a “fat client” model, the client computers do most of the processing and only data for communication and storage is passed to the server.

Thin client architecture is generally preferred in larger enterprise settings because it enables greater centralization and control of system security due to the concentration of processing and data storage on the server. In some prior thin client systems, simple client terminals are provided to the users, and these terminals are communicatively connected to a server. Sometimes known as “dumb” terminals, the client hardware includes simply a monitor, data input devices such as a keyboard and mouse, connectivity means for communicating with the remote server, which may be a mainframe. While these systems are relatively easy to manage and secure in that nearly all processing occurs on the server where it can be centrally monitored and controlled, a disadvantage is that the connectivity means typically uses proprietary technology and thus is not interchangeable with other systems. Another drawback is that the hardware can be relatively expensive to acquire.

Another approach has been to use a personal computer running a general purpose operating system such as Microsoft® Windows® as the client device that is physically connected to the server through LAN or WAN technology. Software, for instance a Independent Computing Architecture (ICA) or Remote Desktop Protocol (RDP) client, is used to display a user interface for accessing programs that actually run on the server, thereby creating a thin client. An advantage of this approach is that personal computers are inexpensive and readily available. A significant drawback, however, lies in the plethora of resources made available by the personal computer that may be locally available to the user.

Most computer users, especially in larger commercial and governmental enterprises, are provided a computer to perform only a limited set of tasks. For example, workers may be assigned to a call center where the only computer related tasks to be performed by the worker involve entry of data into an order-taking or data collection oriented database. On the personal computer, there may be a multitude of programs that are set to run automatically or that the user may have installed and can run if they start the program(s). If these other applications or resources are locally available, the users may be tempted to explore and use them, thus distracting from the assigned tasks.

Resources commonly available on personal computers include USB ports that can be used to access removable flash drives and the like, and writable CD and DVD drives, along with drivers and support files in the general operating system that enable use of these devices. Also, the operating system may enable access to other applications for which the user may have no legitimate business use, and if connected with the internet, may enable remote access to the computer from virtually any location. All of these drawbacks present the potential for theft, security breaches, and loss of employee productivity. Consequently, where personal computers are used as client devices, it is highly desirable to prevent or sharply inhibit user access to resources of the client computer.

In some cases, client-server system managers have resorted to physically disabling resources on client computers to make them unavailable, for example by filling USB ports with glue, disconnecting local storage devices such as non-boot disk drives, and deleting software. Drawbacks of this approach are that the resources are not available to an administrator or other authorized user, and the computer may be physically damaged, reducing its value and reusability.

A known way of generally limiting available resources of a personal computer is through shell replacement. A shell is software that provides an interface for users to access and use services provided by the operating system “kernel.” Microsoft® Windows®, for example, uses a default shell, Windows® Explorer, that is responsible for displaying the desktop and the file browser. The default shell functions mainly to launch other programs upon request. When a user logs on, a user initialization program known as “userinit.exe” restores the network connections, enables device drivers, establishes profile settings, such as fonts and screen colors, runs the user's logon scripts, and starts any user interface shell programs (by default, Windows® Explorer) as a part of the start-up sequence of the computer.

An alternative shell to the default Windows® shell can be loaded by changing an entry in the operating system registry that specifies the shell. “Userinit.exe” will then launch the replacement shell instead of the standard shell after a user logs into the computer. A replacement shell can be created and loaded that only allows users the option of using the necessary functionality to use the computer for the limited purpose for which they are employed. However, by the time the replacement shell is loaded, everything in the startup sequence initiated by “userinit.exe” has already been executed. Thus, if the user can find a way to exit or terminate the replacement shell program, the user has access to all the other resources and functions of the computer enabled by “userinit.exe,” such as local data storage, USB ports, network and internet connections, the user's profile, and visual settings.

Another known way of limiting or “locking down” access to personal computer operating system functionality as well as access to and functionality of installed applications is by imposing server level permissions, sometimes known as “policies and profiles.” For example, an administrator may assign users to one or more defined “groups” of users based on the job related tasks that the user performs. Access permissions are then assigned to each group so that the users in that group all have the assigned permissions A drawback of this approach, however, is that certain users may have slightly different job related needs than other users. Consequently, a large number of different user groups may need to be defined, increasing management complexity, or certain users may have access to more resources than necessary.

Another known way of limiting a user's access to resources without shell replacement in a Microsoft® Windows® system is by individually altering user permissions and the system's registry settings. This can be prohibitively time-consuming, however, as hundreds or even thousands of settings may need to be altered and then tested to adequately limit access to the desired degree. Another drawback is that is even one setting is incorrect, the user may be able to circumvent the restrictions, or alternatively, may be prevented from performing the legitimate tasks to which the user is assigned. Moreover, in a large enterprise where hundreds or thousands of individual computers must be managed, this solution is practically impossible to accomplish and manage.

Accordingly, what is still needed is a system and method that can reliably limit a restricted user's access to resources on client computer, wherein the system is easy to set up and manage and allows authorized users to access the full range of capabilities of the system while preventing the restricted user from accessing any resources outside of those they are approved to use.

### SUMMARY OF THE INVENTION

Embodiments of the invention address the need for a system and method that can reliably limit a restricted user's access to resources on a client computer, wherein the system is easy to set up and manage and allows authorized users to access the full range of capabilities of the system while preventing the restricted user from accessing any resources outside of those they are approved to use. An embodiment of the invention includes a computer usable medium having computer readable instructions stored thereon for execution by a client computer in a client-server computing system including a server. The client computer is operated with a general purpose operating system and presents a plurality of resources. The computer readable instructions are for performing a method including steps of interrupting a start-up boot process of the general purpose operating system before a standard operating system user initialization program is executed, enabling one or more permitted resources on the client computer, each permitted resource selected from the plurality of resources, automatically executing an alternative user interface program on the client computer, the alternative user interface program selected from the group consisting of a remote desktop access program and a task-oriented computer program, detecting termination of the alternative user interface program, and automatically restarting the alternative user interface program after termination. According to the embodiment, the alternative user interface program serves as a sole user interface for the general purpose operating system and limits access by a user of the client computer to only the one or more permitted resources.

The remote desktop access program may be an Independent Computing Architecture client or a Remote Desktop Protocol client. The task-oriented computer program may be a browser or any other single application such as a custom mission critical application providing access to data on a server, or a terminal emulation application which connects to a mainframe. In a further embodiment, the general purpose operating system is Microsoft® Windows® or a descendant, variant, or derivative work thereof. The one or more permitted resources may includes a communicative connection with the server.

In an embodiment, a method of managing at least one client computer in a client-server computing system that includes a server, the at least one client computer being operated with a general purpose operating system and presenting a plurality of resources, includes interrupting a start-up boot process of the general purpose operating system before a standard operating system user initialization program is executed, enabling one or more permitted resources on the at least one client computer, each permitted resource selected from the plurality of resources, wherein the one or more permitted resources includes a communicative connection with the server, automatically executing an alternative user interface program on the at least one client computer, the alternative user interface program selected from the group consisting of a remote desktop access program and a task-oriented computer program, detecting termination of the alternative user interface program, and automatically restarting the alternative user interface program after termination. The alternative user interface program serves as the sole user interface to the general purpose operating system for a user of the at least one client computer, and limits access by the user to the plurality of resources to only the one or more permitted resources. The method may also include storing, on a computer readable medium associated with the client computer, computer readable instructions for performing the method.

In embodiments of the invention, the general purpose operating system may enable defining a plurality of user accounts, and the method may further include defining at least one user account for the user, associating the permitted resources with the at least one user account, and associating a command string for executing the alternative user interface program with the at least one user account. Further, the method may include automatically logging on the user to the at least one client computer using the at least one user account, and the step of enabling one or more permitted resources on the at least one client computer may be performed automatically when the user is logged on. In other embodiments, the general purpose operating system may enable defining a plurality of user accounts, and the method may further include defining a plurality of user accounts, each defined user account being for a separate user, and associating different permitted resources with each user account.

Certain embodiments of the invention may include a method of managing a plurality of client computers in a client-server computing system that includes a server, each client computer being operated with a general purpose operating system and presenting a plurality of resources. The method includes storing, on a computer readable medium associated with each client computer, computer readable instructions for the client computer. The instructions stored are for performing a method including interrupting a start-up boot process of the general purpose operating system before a standard operating system user initialization program is executed, enabling one or more permitted resources on the client computer, each permitted resource selected from the plurality of resources, automatically executing an alternative user interface program on the client computer, the alternative user interface program selected from the group consisting of a remote desktop access program and a task-oriented computer program, detecting termination of the alternative user interface program, and automatically restarting the alternative user interface program after termination. The alternative user interface program serves as the sole user interface to the general purpose operating system for a user of the client computer, and limits access by the user to the plurality of resources to only the one or more permitted resources. The one or more permitted resources may include a communicative connection with the server. The step of storing, on a computer readable medium associated with each client computer, computer readable instructions for the client computer, may be performed automatically when the client computer is communicatively connected with the server.

Embodiments of the invention greatly reduce the time, effort, and expense devoted to management of user accessable computer resources. User access on the client computer is limited to single application, which may be an ICA or RDP session. Hence, there is only one application that needs to be managed, and all “locking down” of user access may be done at the server level.

An advantage of certain embodiments of the invention is that any single application capable of execution by entry of a command may be used as the user interface to a general purpose operating system of a client computer.

An advantage of certain embodiments of the invention is that a user may be easily restricted to using only a single application needed for performance of the user's job responsibilities.

An advantage of certain embodiments of the invention is that a user may be easily limited to using only a suite of applications provided in a desktop environment specified at the server, thereby limiting the user's use of the client computer to only those applications needed for performance of the user's job responsibilities.

An advantage of certain embodiments of the invention is that only those client computer resources needed for performance of the user's job responsibilities may be enabled while other client computer resources are not enabled and are inaccessible to the user.

An advantage of certain embodiments of the invention is that older, depreciated personal computer hardware can be used as a client device in a client-server environment for task oriented employee-users, thereby extending the useful life of such equipment.

An advantage of certain embodiments of the invention is that personal computer hardware can be used as a client device in a client-server environment without compromising security of data on the server, and thereby avoiding the expense associated with proprietary client terminal hardware.

An advantage of certain embodiments of the invention is that older general purpose operating system software can be used for client computers in a client-server computing environment, thereby avoiding the expense and difficulty associated with operating system upgrades.

An advantage of certain embodiments of the invention is that the expense and difficulty associated with restricting user access to resources through shell replacement may be avoided.

An advantage of certain embodiment of the invention is that the expense and difficulty associated with placing individual permission based restrictions on client computer resources may be avoided.

These and other objects, features, and advantages of this invention will become apparent from the description which follows, when considered in view of the accompanying drawings.

### BRIEF DESCRIPTION OF THE DRAWINGS

The invention may be more completely understood in consideration of the following detailed description of various embodiments of the invention in connection with the accompanying drawings, in which:

FIG. 1 is a schematic depiction of a process for managing client computers in a client-server computing environment according to an embodiment of the invention;

FIG. 2 is a flowchart depiction of an alternative interface process according to an embodiment of the present invention; and

FIG. 3 is a high level schematic depiction of an alternative interface system according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

“Operating system,” as used herein, means a set of computer programs that manage the hardware and software resources of a computer. The operating system controls and allocates memory, prioritizes system requests, controls input and output devices, facilitates networking and manages file systems. “General purpose operating system” means an operating system for a personal computer such as IBM® compatible personal computers and Apple® Macintosh® compatible computers, and includes Windows®, Apple® Mac® OSX, and Linux®. “Windows®” is used herein to refer generally to all versions of the general purpose operating systems for personal computers produced by Microsoft®, Inc. of Redmond, Wash., USA, including without limitation, Windows® 95, Windows® NT, Windows® 98, Windows® 2000, Windows® Server 2003, Windows® XP, Windows® Vista, and any descendants, variants, and derivative works thereof. “Client-server” refers to a computing architecture in which at least one computer, referred to a “client,” is communicatively connected to at least one other computer, referred to as a “server.” The client computer initiates requests made to the server, waits for and receives replies from the server computer, and interacts directly with the user. The server computer is a device that waits for requests from the client computers and, upon receipt of requests, processes them and serves replies.

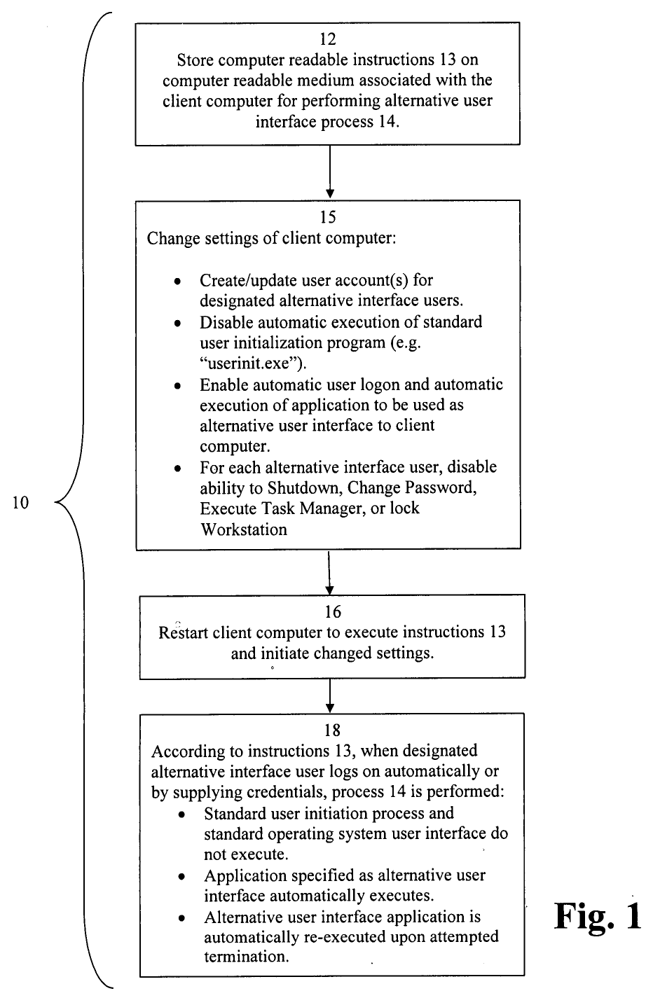

Referring to FIG. 1 there is depicted a schematic diagram of a process 10 for managing client computers in a client-server computing environment, whereby user access to resources of the client computers is restricted. According to process 10, first step 12 includes storing computer readable instructions 13 on a computer readable medium associated with the client computer for performing an alternative user interface process 14. The computer readable medium is preferably the boot volume of the client computer, and may be a hard disk drive, EEPROM, removable storage volume, or any other suitable hardware device associated with the client computer. Computer readable instructions 13 may be the source code instructions of Appendix A previously incorporated by reference, after they have been complied into machine readable form, or other instructions performing the same or similar functions and processes. Step 12 may be performed locally on single client computers on an individual basis, or on a plurality of client systems at once remotely via a server using a batch software installation application as is commonly known in the art to copy the compiled executable files and associated component libraries embodying instructions 13. This second option can be advantageous for an enterprise looking to configure many similar or identical client computers for a number of employees needing to run only a single application. In either case, the installation process is a simple procedure that requires no specialized training and can be accomplished in a matter of minutes.

Next, at step 15, the settings of the client computer are changed to configure the general purpose operating system of the client computer to execute instructions 13 and implement alternative interface process 14. Step 15 generally includes creating a special user account that will be automatically logged on when the operating system boots on the client computer. Alternatively, or in addition to creating the special user account, other user accounts may be created for one or more users that will log-on to the client computer by supplying credentials in the form of a user name and password, but whose access to resources of the client computer is to be restricted. Step 15 also generally includes modifying the registry settings for each user account subject to alternative interface process 14 to disable automatic execution of the standard user initialization program (e.g. “userinit.exe”), enable automatic user logon of the special user account if used, enable automatic execution of the application that will be used as the alternative user interface to client computer, and disable the ability of the user to Shutdown, Change Password, Execute Task Manager, or lock Workstation.

Step 15 may be performed at the same time as step 12 or at any time after instructions 13 have been installed on the client computer. Advantageously, known commercially available software installation programs may be used to make these changes in the registry of the client computer automatically.

According to embodiments of the invention, any application that can accept command line parameters to start execution may be used as the alternative user interface application. The command string for executing the alternative user interface application can be stored as a key value in the registry for each user and is read and executed upon logon of the user. Those of skill in the art will appreciate that that alternative user interface application for each user may be separately specified, so that different users may have different specified alternative user interface applications. When each particular user logs in, the command string for the alternative user interface application for that particular user is retrieved from the registry and executed.

In embodiments of the invention, the alternative user interface application can be, for example, a browser such as Microsoft® Internet Explorer, a custom mission critical application providing access to data on a server, or a terminal emulation application which connects to a mainframe. Alternatively, the alternative user interface application can an Independent Computing Architecture (ICA) client such as Citrix® Netscaler®, Citrix® Presentation Server™, or Citrix® Desktop Server™, or a Remote Desktop Protocol (RDP) client such as Microsoft® Remote Desktop enabling access to a remote server. The ICA client or RDP client application may display a user interface shell or desktop that is actually executing on the server and that enables the user to then execute multiple other applications, also on the server.

In all these embodiments, the alternative user interface application is effectively substituted for the default user interface shell as the operating system user interface on the client computer. One of skill in the art will recognize that, in addition to Windows® computers, process 10 may be adapted for use with any operating system such as for instance, Linux®, or Apple® OS X.

Referring once again to FIG. 1, after completion of step 15, the client computer is restarted at step 16 to execute instructions 13 and initiate the client computer settings changed at step 15. Once restarted, the client computer automatically executes instructions 13, thereby performing alternative interface process 14 as described further herein below.

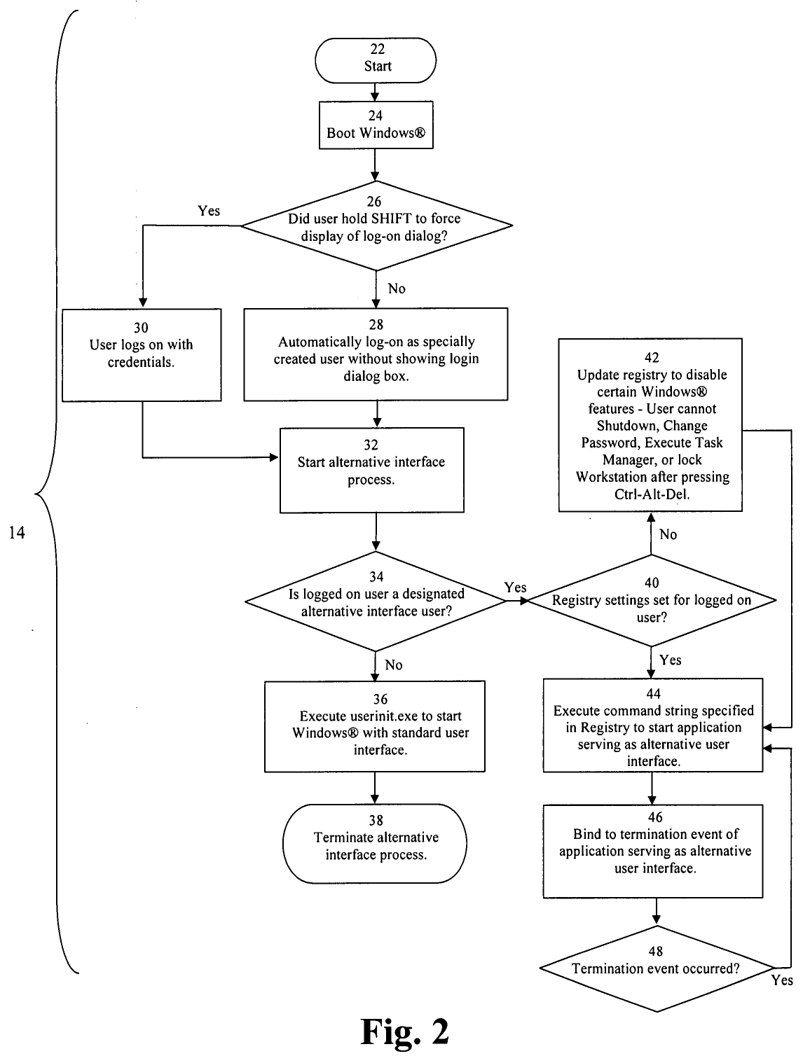

Referring now to FIG. 2, alternative interface process 14 is begun at step 24 when the general purpose operating system (depicted in FIG. 2 as Windows®) is booted on the client computer. At step 26, the system determines whether or not a specific boot process interrupt event occurred, such as whether the SHIFT key was held down as the operating system loads. If not, at step 28, the special user account created upon installation is automatically logged on. If the boot process interrupt event occurred, the user is prompted with the standard user logon dialog box to enter logon credentials at step 30. This enables an administrator, or anyone with the proper permissions, to regain control of the system and reconfigure settings and/or uninstall instructions 13, or to access other system functions. It will be appreciated that, alternatively, there may be no automatic login and all users must logon with credentials each time the operating system is booted.

At logon, client computer resources appropriate for use by the user may be enabled. For example, device drivers for networking cards may be loaded and a communicative connection with one or more servers through a local or wide area network may be established, and drivers for local printers may be loaded. Other client computer resources not needed for the tasks that the user will be performing, such as USB and serial port drivers, are not enabled.

After automatic logon at step 28 or successful manual logon with credentials at step 30, instructions 13 are executed at step 32 before the standard user initialization program of the operating system, such as “userinit.exe” in Windows® is executed. At step 34, the identity of the logged on user is checked to see if the logged on user is a designated alternative interface user. If not, at step 36, the standard user initialization program, such as “userinit.exe” in Windows® is executed and the standard shell and user interface is displayed. Process 14 then terminates at step 38.

If the logged on user is a designated alternative interface user, the registry settings for the logged on user are checked at step 40 to see if certain features are disabled. If not, at step 42 user specific registry settings are updated to disable certain operating system features, such as, for example, Shutdown, Change Password, Execute Task Manager, or Lock Workstation, and any other features tending to enable the user to escape the alternative user interface application without shutting off the client computer. After confirming and/or setting the registry settings, at step 44 the command string for the alternative user interface application is retrieved from the registry and executed. This loads the alternative user interface application, which then effectively becomes the user interface to the general purpose operating system on the client computer. The user only sees this alternative user interface application instead of the operating system's standard user interface because the operating system's default startup command (e.g. “userinit.exe”) has been bypassed. Moreover, access to resources of the client computer is sharply restricted or entirely eliminated because the standard user initialization program that enables those resources has not been executed.

At step 46, the occurrence of any termination event for the alternative user interface application is bound to re-execution of the command string for he alternative user interface application. A termination event can include any attempt to exit the alternative user interface application that does not turn off the computer or otherwise log off the user. Thus, if a user attempts to get out of the alternative user interface application at step 48, the command string for the alternative user interface application is re-executed at step 44. The alternative user interface application can only be successfully exited by restarting the operating system, logging off the user, or by some error occurring on the local system that causes termination of critical processes. Any other attempt by the user to exit the alternative user interface application will cause the command string to re-execute.

Process 14 thus provides a means of restricting a user's access to resources of a client computer running a general purpose operating system. A limited purpose user, such as a dedicated data entry employee, can be restricted to a single application necessary to perform the user's job. The user is prevented from exiting the single application and can therefore not modify or damage the system or waste time and productivity exploring the non-job related capabilities of the operating system. Moreover, any undesirable resources are simply unavailable on the system because the default user initialization program that enables those resources was bypassed and never executed. Because an administrator or other person with authorization can log into the operating system normally, however, the full range of resources of the client computer can still be used when desired by the administrator or other person with authorization.

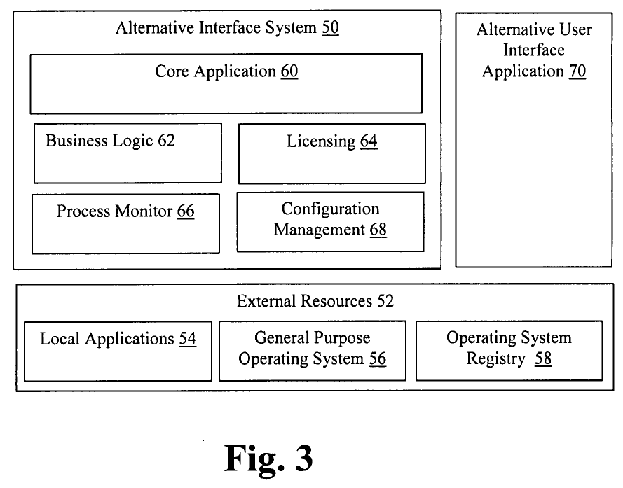

Referring now to FIG. 3, the components of an alternative interface system 50 including instructions 13 are depicted in schematic form. Alternative interface system 50 interacts with external resources 52, including the local computer applications 54 and general purpose operating system 56 and registry 58. Alternative interface system 50 generally includes a compiled core application 60 which is responsible for controlling the execution of all of the other components of alternative interface system 50.

All core decisions in alternative interface system 50 are made by business logic component 62. Business logic component 62 is responsible for making decisions on which components of alternative interface system 50 are invoked based on specific operating conditions. For example, business logic component 62 can determine how to start the system, including whether or not the operating system should be started normally, which alternative user interface application to launch, and how to enforce licensing. Alternative interface system 50 can include a specific licensing component 64 that interacts with business logic component 62. Licensing component 64 can ensure that alternative interface system 50 is running in a licensed environment. If alternative interface system 50 is not running in a licensed environment, it can be operated in a trial mode.

Another component of alternative interface system 50 is process monitor 66. Process monitor 66 responds to a termination event of the alternative user interface application. When the process monitor 66 detects a termination event, it automatically re-executes the command string, which is retrieved from the configuration management component 68 of shell alternative interface system 50, and the alternative user interface application is reloaded. The configuration management component 68 manages access to the operating system registry, where all parameters for alternative interface system 50 are stored. It is also responsible for checking for and enforcing the correct registry values to disable operating system functions, such as, for example, shutdown, lock workstation, change password, and task manager.

As a whole, alternative interface system provides a means by which alternative interface user application 70 in the form of any application capable of execution by a command may be used as the user interface to a general purpose operating system of a client computer. Alternative interface system 50 thus provides a means by which process 14 can be performed in order to limit user access to resources of a client computer. A user is locked into this limited functionality mode because the process monitor 66 prevents the user from exiting and accessing the broader range of system resources. A user with the proper permissions, however, can utilize the full functionality and resources of the client computer. Thus, businesses desiring to prevent employees who need computers for only a limited purpose can prevent those employees from accessing undesired resources of the client computers, but the client computers need not be physically disabled or otherwise altered. Alternative interface system 50 according to embodiments of the present invention can therefore turn a personal computer into a thin client computer.

The embodiments above are intended to be illustrative and not limiting. Additional embodiments are encompassed within the scope of the claims. Although the present invention has been described with reference to particular embodiments, those skilled in the art will recognize that changes may be made in form and detail without departing from the spirit and scope of the invention. For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A computer usable medium having computer readable instructions stored thereon for execution by a client computer in a client-server computing system including a server, the client computer operated with a general purpose operating system and presenting a plurality of resources, the computer readable instructions for performing a method comprising:
interrupting a start-up boot process of the general purpose operating system before a standard operating system user initialization program is executed;
enabling one or more permitted resources on the client computer, each permitted resource selected from the plurality of resources,
automatically executing an alternative user interface program on the client computer, the alternative user interface program selected from the group consisting of a remote desktop access program and a task-oriented computer program;
detecting termination of the alternative user interface program; and
automatically restarting the alternative user interface program after termination,
wherein the alternative user interface program serves as a sole user interface for the general purpose operating system and limits access by a user of the client computer to only the one or more permitted resources.

2. The computer usable medium of claim 1, wherein the remote desktop access program is selected from the group consisting of an Independent Computing Architecture client and a Remote Desktop Protocol client.

3. The computer usable medium of claim 1, wherein the task-oriented computer program is a browser.

4. The computer usable medium of claim 1, wherein the general purpose operating system is Microsoft® Windows®.

5. The computer usable medium of claim 1, wherein the one or more permitted resources includes a communicative connection with the server.

6. A method of managing at least one client computer in a client-server computing system that includes a server, the at least one client computer being operated with a general purpose operating system and presenting a plurality of resources, the method comprising:
interrupting a start-up boot process of the general purpose operating system before a standard operating system user initialization program is executed;
enabling one or more permitted resources on the at least one client computer, each permitted resource selected from the plurality of resources, wherein the one or more permitted resources includes a communicative connection with the server;
automatically executing an alternative user interface program on the at least one client computer, the alternative user interface program selected from the group consisting of a remote desktop access program and a task-oriented computer program;
detecting termination of the alternative user interface program; and
automatically restarting the alternative user interface program after termination,
wherein the alternative user interface program serves as the sole user interface to the general purpose operating system for a user of the at least one client computer, and limits access by the user to the plurality of resources to only the one or more permitted resources.

7. The method of claim 6, wherein the remote desktop access program is selected from the group consisting of an Independent Computing Architecture client and a Remote Desktop Protocol client.

8. The method of claim 6, wherein the task-oriented computer program is a browser.

9. The method of claim 6, wherein the general purpose operating system is Microsoft® Windows®.

10. The method of claim 6, further comprising storing, on a computer readable medium associated with the client computer, computer readable instructions for performing the method.

11. The method of claim 6, wherein the general purpose operating system enables defining a plurality of user accounts, the method further comprising defining at least one user account for the user, associating the permitted resources with the at least one user account, and associating a command string for executing the alternative user interface program with the at least one user account.

12. The method of claim 11, further comprising automatically logging on the user to the at least one client computer using the at least one user account, and wherein the step of enabling one or more permitted resources on the at least one client computer is performed automatically when the user is logged on.

13. The method of claim 6, wherein the general purpose operating system enables defining a plurality of user accounts, the method further comprising defining a plurality of user accounts, each defined user account being for a separate user, and associating different permitted resources with each user account.

14. A method of managing a plurality of client computers in a client-server computing system that includes a server, each client computer being operated with a general purpose operating system and presenting a plurality of resources, the method comprising:
storing, on a computer readable medium associated with each client computer, computer readable instructions for the client computer, the instructions for performing a method including:
interrupting a start-up boot process of the general purpose operating system before a standard operating system user initialization program is executed;
enabling one or more permitted resources on the client computer, each permitted resource selected from the plurality of resources;
automatically executing an alternative user interface program on the client computer, the alternative user interface program selected from the group consisting of a remote desktop access program and a task-oriented computer program;
detecting termination of the alternative user interface program; and
automatically restarting the alternative user interface program after termination,
wherein the alternative user interface program serves as the sole user interface to the general purpose operating system for a user of the client computer, and limits access by the user to the plurality of resources to only the one or more permitted resources.

15. The method of claim 14, wherein the general purpose operating system is Microsoft® Windows®.

16. The method of claim 14, wherein the general purpose operating system enables defining a plurality of user accounts, the method performed by the instructions further comprising defining at least one user account for the user, associating the permitted resources with the at least one user account, and associating a command string for executing the alternative user interface program with the at least one user account.

17. The method of claim 16, wherein the method performed by the instructions further comprises automatically logging on the user to the client computer using the at least one user account, and wherein enabling one or more permitted resources on the client computer is performed automatically when the user is logged on.

18. The method of claim 14, wherein the general purpose operating system enables defining a plurality of user accounts, the method performed by the instructions further comprising defining a plurality of user accounts, each defined user account being for a separate user, and associating different permitted resources with each user account.

19. The method of claim 14, wherein the one or more permitted resources includes a communicative connection with the server.

20. The method of claim 14, wherein the step of storing, on a computer readable medium associated with each client computer, computer readable instructions for the client computer, is performed automatically when the client computer is communicatively connected with the server.
